(19) United States
(12) Patent Application Publication
(10) Pub. No.: US 2020/0017097 A1
(43) Pub. Date: Jan. 16, 2020

(54) BATTERY PROTECTION WITH DOWNHILL CHARGE SUSTAIN

(71) Applicant: Byton North America Corporation, Santa Clara, CA (US)

(72) Inventors: Eric Money, San Jose, CA (US); Pranav Ajit Sane, Santa Clara, CA (US)

(21) Appl. No.: 16/035,379

(22) Filed: Jul. 13, 2018

(51) Int. Cl. B60W 20/13; B60W 10/26; B60L 11/18; B60L 7/14

(52) U.S. Cl. CPC B60W 20/13; B60W 10/26; B60W 2510/244; B60L 7/14; B60L 11/1861

(57) ABSTRACT

Downhill charge sustain battery protection strategy is disclosed. For one example, a vehicle is powered by an electric motor and battery. The vehicle includes a vehicle control unit (VCU) to control friction braking and regenerative braking for the vehicle. For one example, the VCU is configured to implement a method comprising detecting a condition to switch back and forth between regenerative braking and friction braking. For one example, the detected condition is a charge sustain event such as, for example, the vehicle being at a top of a hill or going down a hill in a lift condition (no pedals pressed) and the battery is fully charged at maximum state of charge (SOC) or voltage limit.

### FIELD

Embodiments of the invention are in the field of electric power and control systems for vehicles using electric motors. More particularly, embodiments of the invention relate to battery protection with downhill charge sustain.

### BACKGROUND

Electric powered vehicles are gaining popularity due to its use of clean energy. Such vehicles have electric motors which can be powered by rechargeable batteries. Electric motors are continuously connected to a battery and the wheels of a vehicle. In one instance, an electric motor can receive power from the battery and generate torque to rotate the wheels of the vehicle which cause the vehicle to move. In another instance, the electric motor can be inverted to receive kinetic energy from the motion of the wheels and generate electric power used to recharge the battery. This process of inverting the electric motor can slow the vehicle and is referred to as regenerative braking. Regenerative braking is an energy recovery process that slows the vehicle down by converting kinetic energy into electrical energy unlike friction braking which uses brake pads to slow a vehicle.

In certain instances, a battery can be fully charged while a vehicle is experiencing a sudden acceleration event such as coasting down a hill, which can cause a runaway condition in terms of vehicle speed. If a brake pedal is pressed and manual or friction braking is applied, the brakes may overheat in this runaway condition. And, if the accelerator pedal is in a lift position as well as the brake pedal, the motor is still continuously connected to the wheels and the rotation of the wheels provides kinetic energy to the motor recharging the battery. In the event of the battery charging during a runaway condition, this can be problematic because the battery may overcharge beyond its maximum limit causing the voltage level in the individual cells of the battery to surge. As a result, the thermal level in the battery can spike, possibly causing the battery to catch on fire. Such an event can be dangerous to the driver and passengers and may cause severe damage to the vehicle.

### SUMMARY

Embodiments and examples are disclosed to implement a downhill charge sustain battery protection strategy. For one example, a vehicle is powered by an electric motor and battery. The vehicle includes a vehicle control unit (VCU) to control friction braking and regenerative braking for the vehicle. For one example, the VCU is configured to implement a method comprising detecting a condition to switch back and forth between regenerative braking and friction braking. For one example, the detected condition is a charge sustain event such as, for example, the vehicle being at a top of a hill or going down a hill in a lift condition (no pedals pressed) and the battery is fully charged at maximum state of charge (SOC) or voltage limit.

Because the electric motor is continuously connected to the wheels and battery, even if no pedals are pressed, the rotation of the wheels going down-hill creates kinetic energy which is converted to electrical energy by the electric motor and supplied to the battery. In this process of regenerative braking, the electric motor is not generating torque to drive the wheels, but rather generating electric energy used for recharging the battery. However, if the battery is fully charged when going down-hill, regenerative braking may overcharge the battery beyond its SOC or voltage limit. Thus, in this charge sustain event, switching back and forth between regenerative braking and friction braking can protect the battery from overcharging beyond its maximum limit. The VCU can trigger the switching between regenerative braking and friction braking at a frequency range of greater than 100 hertz and less than 400 hertz. Such a frequency range can avoid vibration and prevent unwanted noise within the vehicle.

For one example, friction braking may cause the temperature on brake components to rise at or beyond an acceptable limit or threshold which can be detected by the VCU. In such an instance, the VCU can blend-out friction braking and blend-in regenerative braking decreasing the temperature on the brake components. For one example, the VCU can also detect if the battery reaches an acceptable SOC or voltage limit or threshold to blend-out regenerative braking and blend-in friction braking to sustain a sufficient charge on the battery. In this way, the charge sustain event battery protection strategy can also prevent overheating of brake components.

Other systems, apparatuses, computer readable-mediums and vehicles are described.

### BRIEF DESCRIPTION OF THE DRAWINGS

The appended drawings illustrate examples and embodiments and are, therefore, exemplary and not considered to be limiting in scope.

FIG. 1 illustrates one example of a vehicle capable of implementing a charge sustain event battery protection strategy.

FIG. 2A illustrates one example of a block diagram of a system for vehicle to implement a charge sustain battery protection strategy.

FIG. 2B illustrates exemplary communication between a brake system and a powertrain system to implement a charge sustain event battery protection strategy.

FIG. 2C illustrates an exemplary diagram of a braking system and powertrain system of a vehicle.

FIG. 2D illustrates exemplary graphs showing comparison of regenerative braking blending-in for non-break-by-wire and break-by-wire implementations with respect to pressing of an accelerator pedal and brake pedal.

FIG. 3A-3B illustrates exemplary flow diagrams of operations to implement a charge sustain battery protection strategy.

FIG. 4 illustrates exemplary graphs of switching between regenerative braking and friction braking with relation to braking temperature, battery state of charge (SOC), and parasitic elements in a run-away speed downhill scenario.

FIG. 5 illustrates another exemplary flow diagram of a sustain charge operation to implement a battery protection strategy.

FIG. 6A-6D illustrates exemplary graphs of switching between regenerative braking and friction breaking requests with relation to vehicle velocity and battery state of charge (SOC).

FIG. 7 illustrates one example of a data processing system, computing system, or computer for a vehicle.

### DETAILED DESCRIPTION

The following detailed description provides embodiments and examples to implement a downhill charge sustain battery protection strategy. For one example, a vehicle includes a vehicle control unit (VCU). The VCU detects a charge sustain event condition to trigger a braking strategy of switching between regenerative braking and friction braking that can sustain a sufficient charge for the battery without exceeding its maximum limits and even prevent braking components from overheating.

One example condition to trigger a charge sustain event is a vehicle at or near a top of a hill or going down a hill in a lift condition (no pedals pressed) and the battery is fully charged at its maximum state of charge (SOC) or voltage limit. In this condition, the vehicle may experience a break-away speed situation and instead of continuously applying regenerative braking, which can charge the battery beyond is maximum SOC and voltage limit, the VCU can switch the vehicle between regenerative braking and friction such that the battery does not exceed its maximum SOC and voltage limit. If a temperature of one of the braking components exceeds a maximum limit, the VCU can also blend-out friction braking and blend-in regenerative braking thereby preventing braking components from overheating.

For one example, the VCU is coupled to a location data source to calculate a location of the vehicle and one or more sensors to receive sensor data including temperature, SOC, voltage, etc. related to one or more components of the vehicle. Other charge sustain event conditions to trigger switching between regenerative braking and friction braking can include a temperature of one or more braking components at or beyond a threshold or limit, a temperature related to the battery at or beyond a threshold or limit, or a SOC or voltage level of the battery at or beyond a threshold or limit or any combination of these conditions.

As set forth herein, various embodiments, examples and aspects will be described with reference to details discussed below, and the accompanying drawings will illustrate various embodiments and examples. The following description and drawings are illustrative and are not to be construed as limiting. Numerous specific details are described to provide a thorough understanding of various embodiments and examples. However, in certain instances, well-known or conventional details are not described to facilitate a concise discussion of the embodiments and examples. Although the following examples and embodiments are directed to a battery protection strategy for vehicles, the battery protection strategy disclosed herein can be implemented for any type machine, apparatus, or device using an electric motor and battery.

### Exemplary Vehicle with Battery Protection Strategy

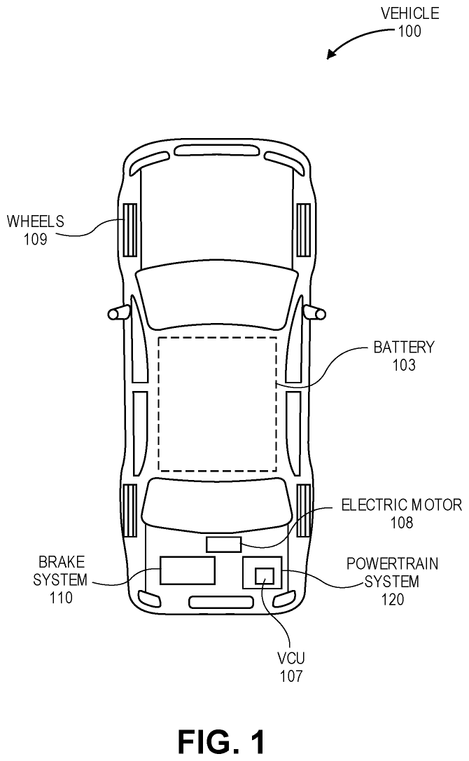

FIG. 1 illustrates one example of a vehicle 100 capable of implementing a charge sustain event battery protection strategy. Vehicle 100 includes an electric motor 108 coupled to battery 103 and wheels 109, brake system 110, and a powertrain system 120 having a vehicle control unit 107. For one example, vehicle 100 can be a hybrid, autonomous or non-autonomous vehicle or electric car. Although vehicle 100 is shown with one electric motor 108 for a two-wheel drive implementation, vehicle 100 can have a second electric motor for a four-wheel drive implementation. For one example, brake system 110 and powertrain system 120 include one or more electronic control units (ECUs) such as VCU 107. For one example, ECUs can be a micro-controller, computing or data processing system, system-on-chip (SOS), or any embedded system that can run firmware or program code stored in one or more memory devices to perform operations or functions and control various components within vehicle 110. For example, brake system 110 can control friction braking to wheels 10 and powertrain system 120 can have electric motor 108 provide torque to drive wheels 109 and invert electric motor 108 to provide regenerative braking and recharge battery 103. The ECUs can be coupled by way of a network topology within vehicle 100 and communicate signals, requests, commands, and etc.

Battery 103 is a rechargeable battery and can power electric motor 108 or other electric motors for vehicle 100. Examples of battery 103 can include lead-acid, nickel-cadmium, nickel-metal hydride, lithium ion, lithium polymer, or other types of rechargeable batteries. For one example, battery 103 can be located on the floor and run along the bottom of vehicle 100. As a rechargeable battery, for one example, battery 103 can be charged by being plugged into an electrical outlet. And, for another example, battery 103 can be charged during regenerative braking when electric motor 108 is inverted (not supplying torque to drive wheels 109) and converting kinetic energy from rotating wheels 109 into electrical energy used for recharging battery 103. The location and number of batteries is not limited to one and can be located throughout vehicle 100 in any location.

Examples of electric motor 108 can include alternating current (AC) induction motors, brushless direct-current (DC) motors, and brushed DC motors. Exemplary motors can include a rotor having magnets that can rotate around an electrical wire or a rotor having electrical wires that can rotate around magnets. Other exemplary motors can include a center section holding magnets for a rotor and an outer section having coils. For one example, when driving wheels 109, electric motor 108 contacts with battery 103 providing an electric current on the wire that creates a magnetic field to move the magnets in the rotor that generates torque to drive wheels 109. When inverted, the contacts between the electric motor 108 and battery 103 allow electric motor 108 to generate electric energy from kinetic energy derived from rotating wheels 109. For instance, the magnetic field from rotating magnets in rotor can create electrical current in the wire to generate electrical energy supplied to battery 103. This conversion of kinetic energy to electrical energy can be used to slow the speed of vehicle 100 during regenerative braking and the generated electrical energy can recharge battery 103.

In this example, electric motor 108 is located at the rear of vehicle 100 to drive back wheels 110 as a two-wheel drive vehicle. For other examples, another electric motor can be placed at the front of vehicle 100 to drive front wheels 109 as a four-wheel drive vehicle. In motion, electric motor 108 is continuously connected to battery 103 and wheels 109 and is either driving wheels 109 or recharging battery 103. For example, in one direction, electric motor 108 can receive electrical energy from battery 103 to create a torque to drive wheels 108. In the other direction, electric motor 108 can receive kinetic energy from rotating wheels 108 and generate electrical energy and supplied to battery 103 as part of regenerative braking.

For one example, brake system 110 provides braking functions for wheels 109 including friction braking using brake pads. Powertrain system 120 controls electric motor 108 to drive wheels 109 or inverts electric motor 108 for regenerative braking to slow the speed of vehicle 100 when electric motor is not driving wheels 109. For one example, brake system 110 and powertrain system 120 communicate signals providing limits and parameters for friction braking and regenerative braking. For example, torque limits for friction braking and regenerative braking can be exchanged between brake system 110 and powertrain system 120.

For one example, VCU 107 of the powertrain system 120 can detect a charge sustain event condition and trigger brake system 110 and powertrain system 120 to implement a battery protection strategy of switching between regenerative braking and friction braking. For example, VCU 107 can receive location data for vehicle 100 to determine that vehicle 100 is at or near a top of a hill or going down a hill. VCU 107 can also receive sensor data or signals from vehicle components indicating that the vehicle 100 is in a lift condition (no pedals pressed) and battery 103 is fully charged at its maximum state of charge (SOC) or voltage limit. In this condition, VCU 107 can determine vehicle 100 is in a charge sustain event because vehicle 100 may enter a break-away speed situation that continuously recharges battery 103 during regenerative braking because electric motor 108 is not driving wheels 109. Alternatively, if this condition is detected, VCU 107 can trigger a battery protection strategy of switching between regenerative braking and friction braking. VCU 107 can control switching of regenerative braking and friction braking such that the charge on battery 103 does not exceed its maximum SOC and voltage limit while sustaining a sufficient charge for the battery 103.

For other examples, VCU 107 can detect other types of charge sustain events including detecting a temperature of one or more braking components at or beyond a threshold or limit, a temperature related to battery 103 at or beyond a threshold or limit, or a SOC or voltage level of the battery 103 at or beyond a threshold or limit or any combination of these conditions. Thus, such a battery protection strategy can also prevent braking components from overheating. Although VCU 107 is shown as part of powertrain system 120, VCU 107 can be a separate controller within vehicle 100 and part of other systems to communicate with any number of ECUs controlling other operations and functions for vehicle 100.

### Exemplary Battery Protection Strategy Systems

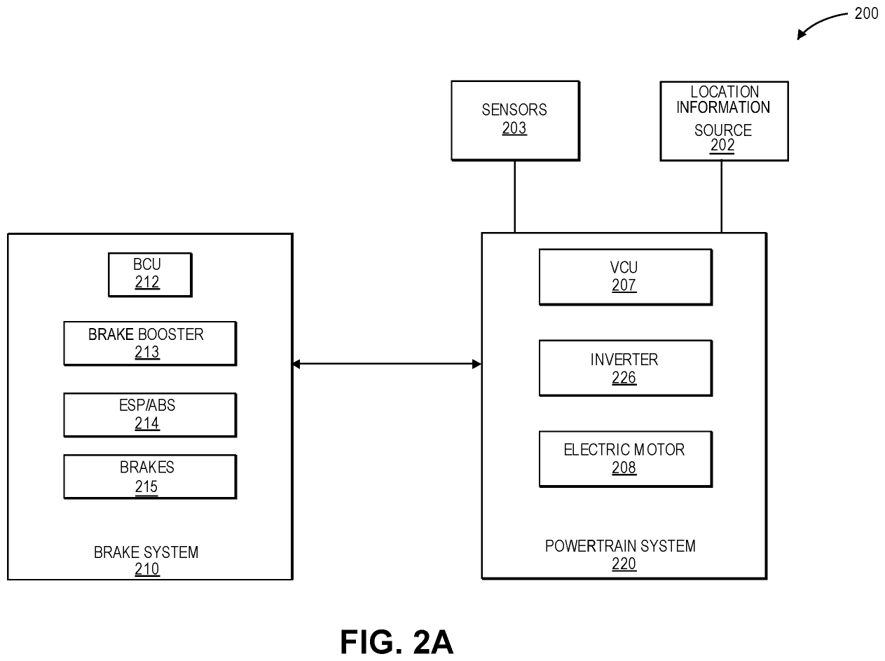

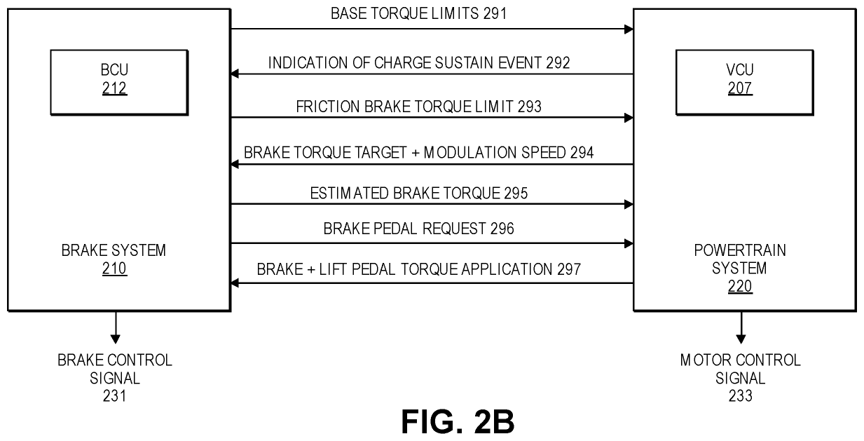

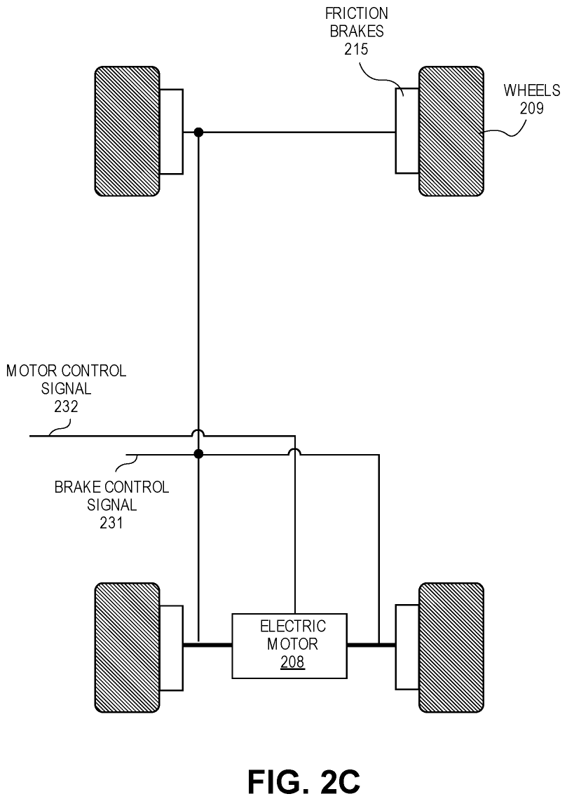

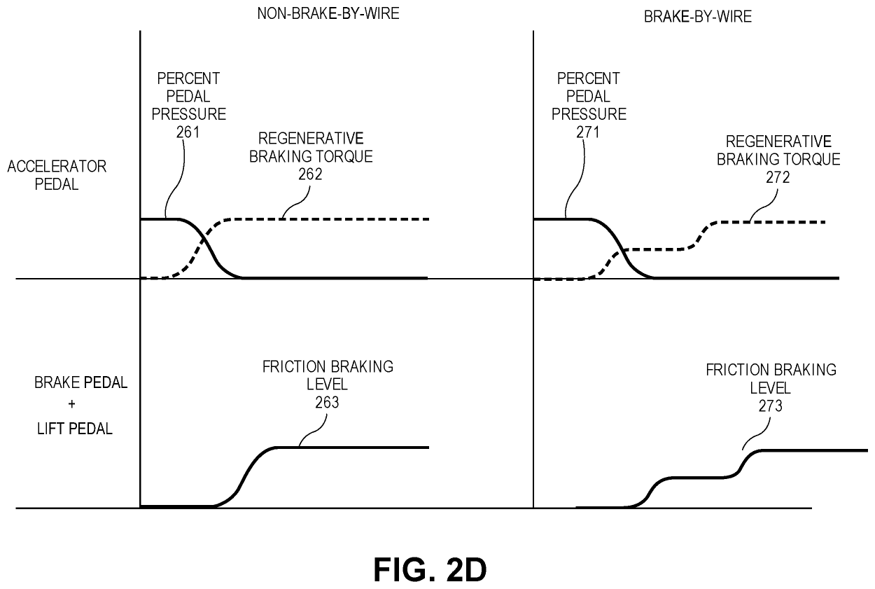

FIG. 2A illustrates one example of a block diagram of a system 200 for vehicle 100 to implement a charge sustain battery protection strategy. Referring to FIG. 2A, system 200 includes a brake system 210 coupled to a powertrain system 220. Brake system 210 includes a brake controller unit (BCU) 212, electro-mechanical brake booster (brake booster) 213, electronic stability programs (ESP)/anti-lock braking systems (ABS) 214 and brakes 215 having brake pads. BCU 212 can control the brake booster 213, ESP/ABS 214 to control the brake pads of brakes 215 in providing friction braking. The brake booster 213 can be used to boost a brake pedal pressure for friction braking and can boost the electrical signal for braking purposes. In other examples, for a brake-by-wire system brake booster 213 can be omitted and braking caused by pressing of a brake pedal can be performed electronically.

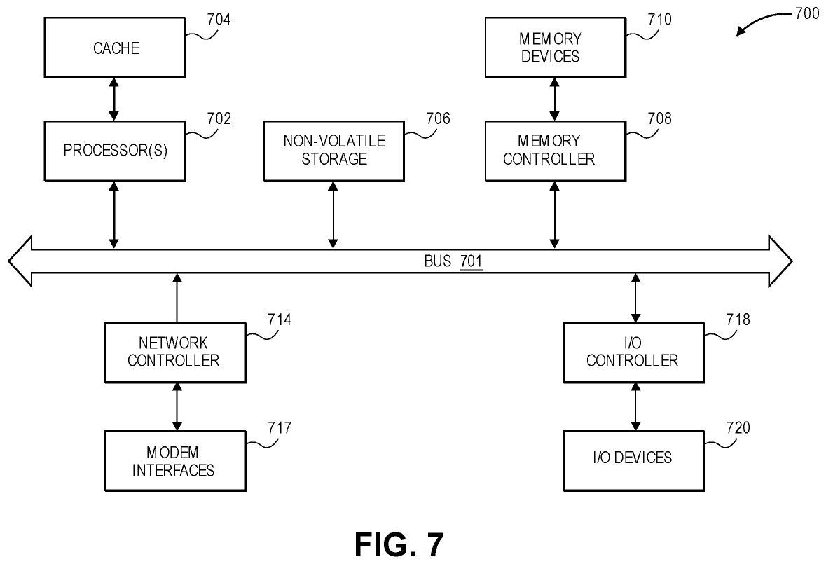

Powertrain system 220 includes a vehicle control unit (VCU) 207, inverter 226, and electric motor 208. VCU 207 can control inverter 226 and electric motor 208 to drive wheels 109 and generate electrical power to recharge battery 103. VCU 207 and BCU 212 can also communicate with each to trigger a sustain charge event and modulate friction braking by BCU 212 in the brake system 210 and regenerative braking by VCU 207 in powertrain system 220 as detailed in FIG. 2B. BCU 212 and VCU 207 can include any type of micro-controller, electronic control unit (ECU), system on a chip (SOC), central processing unit (CPU), microprocessor, data processing system or computing system or other components (e.g., memory devices) as described in FIG. 7.

For one example, VCU 207 is coupled to sensors 203 and location information source 202. Location data source 202 can be an in-vehicle mapping application having mapping data to identify a location for vehicle 100 and include a GPS device to receive precise GPS location data to calculate a geographical position for vehicle by location data source 202 and forwarded to VCU 207. For one example, VCU 207 can receive location information from location data source 202 to detect that that vehicle 100 is at or near the top of a hill. For one example, sensors 203 include any number and types of sensors providing sensor data. For example, sensors 203 can includes sensors to provide brake component temperature, battery 103 temperature, state of charge (SOC) and voltage levels for battery 103, and other types of sensor data to VCU 207. The information and data provided by location information source 202 and sensors 203 to VCU 207 can be used to detect a sustain charge event condition such as, for example, vehicle 100 is at the top of a hill to experience a down-hill scenario and battery 103 is fully charged at its maximum SOC. Other examples of charge sustain event conditions detected by VCU 207 to trigger switching between regenerative braking and friction braking can include a temperature of one or more braking components in brake system 210 at or beyond a threshold or limit, a temperature related to battery 103 at or beyond a threshold or limit, or a SOC or voltage level of battery 103 at or beyond a threshold or limit or any combination of these conditions.

For one example, if a charge sustain event condition is detected, VCU 207 can signal BCU 212 to trigger modulation of friction braking to brakes 215 and VCU 207 can also trigger modulation of regenerative braking by electric motor 208 such that regenerative braking alternates with friction braking. For one example, modulation of friction braking and regenerative braking can be offsetting having sinusoidal signals where regenerative braking can blend-out while friction braking blends-in and vice versa. For one example, the modulated signals can alternate at a frequency range of greater than 100 hertz (Hz) and less than 400 Hz. Such a frequency range can prevent noticeable vibration to a driver or passenger of vehicle 100 or disruptive noise caused by switching between regenerative braking and friction braking.

FIG. 2B illustrates exemplary communication between brake system 210 and powertrain system 220 to implement a charge sustain event battery protection strategy. Referring to FIG. 2B, only the BCU 212 for brake system 210 and VCU 207 for powertrain system 220 are shown. For one example, VCU 207 and BCU 212 can communicate signals 291 through 297 for a charge sustain event condition to implement a battery protection strategy.

Initially, for signal 291, BCU 212 sends to VCU 207 torque limits for powertrain system 220 under normal driving operation. For example, referring to FIG. 1, a rear-axle two-wheel drive implementation, BCU 212 can send the minimum and maximum rear axle torque limits for electric motor 108 to drive wheels 109. In other examples, BCU 212 can send front axle torque limits for another electric motor 108 to drive wheels 109. Such limits can refer to stability limits for vehicle 100.

For signal 292, VCU 207 can detect charge sustain event condition and enable powertrain system 220 to switch between regenerative braking and friction braking. The VCU 207 indicates to BCU 212 of the charge sustain event and enabling of alternating between regenerative braking and friction braking by modulating brake control signal 231 and motor control signal 233 received by electric motor 208 and friction brakes 215 for wheels 209 as shown in FIG. 2C.

For signal 293, the BCU 212 sends friction brake torque limits to VCU 207 indicating braking capabilities for brake system 210 for braking of wheels 109 of vehicle 100. For one example, BCU 212 informs VCU 207 of powertrain system 220 of what brake system 210 is capable of providing for friction braking, e.g., newton-meters of torque at each wheel 109. VCU 207 uses this friction brake torque limits to limit or control the charge-sustain braking or modulation of regenerative braking to achieve a desired charge sustain on battery 103 based on friction brake limit signal 293 from BCU 212.

For signal 294, VCU 207 informs BCU 212 of the amount of friction brake torque target and modulation speed for friction braking to be applied by brake system 210. For example, VCU 207 informs BCU 212 of the rate at which switching or blending of friction braking and regenerative braking should occur during the charge sustain event condition. For one example, VCU 207 informs BCU 212 to switch or alternate friction braking at a modulation speed or frequency in the range of around 100 hertz (Hz) and less than 400 Hz.

For signal 295, BCU 212 sends an estimated brake torque signal 295 to VCU 207 of the brake torque applied by brake system 210 for friction braking during the charge sustain event. That is, the estimated brake torque signal informs VCU 207 of the actual torque applied by brake system 210 during modulation of the friction braking.

For signal 296, brake system 210 may receive a brake pedal request. For this example, BCU 212 sends the brake pedal request 296 to VCU 207. For FIG. 2B, vehicle 100 can operate in a brake-by-wire implementation or in a manual or non-brake by wire implementation as described in FIG. 2D. For one example, in a non-brake by wire implementation, VCU 207 can disable the charge sustain event braking and brake system 210 can process the brake pedal for standard friction braking using brake booster 213 and ESP/ABS 214 and brake pads of brakes 215. For another example in this driver braking scenario, in a brake-by-wire implementation, VCU 207 would send a modification of signal 294 to indicate a portion to add in the braking applied by the brake pedal as shown in friction braking level 273 in FIG. 2D. This can apply the brake pedal request in order to minimize latency. In other examples of a brake-by-wire implementation, the brake pedal request can be adjusted and the sustain charge braking operation can continue.

For signal 297, VCU 207 informs BCU 212 to process brake pedal and that a lift-pedal torque was applied as shown by regenerative braking torque 272 shown in FIG. 2D. This can be a verification that powertrain system 220 is operating within vehicle limits and charge sustain event can be discontinued.

FIG. 2D illustrates exemplary graphs showing comparison of regenerative braking blending-in for non-brake-by-wire and brake-by-wire implementations with respect to pressing of an accelerator pedal and brake pedal. Referring to FIG. 2D, for the non-brake by wire example, as the percentage of the accelerator pedal pressure 261 decreases (going in a lift position or lift pedal position), regenerative braking torque 262 blends-in and reaches full regenerative braking as the accelerator pedal is in a full lift position. For one example, as a brake pedal is being fully pressed and accelerator pedal is in lift pedal position, friction braking level 263 rises and regenerative braking torque 262 can blend-out.

For the brake-by-wire example, as the percentage of the accelerator pedal pressure 271 decreases to go in a lift position, regenerative braking torque 272 rises to a first level. And, if a brake pedal is pressed and in lift pedal position, regenerative braking torque 272 rises to a second level while friction braking level 273 rises to a first level of friction braking as it is blended-in and then friction braking can go to a full level and as regenerative braking torque 272 is blended-out. In the break-by-wire implementation, braking can be controlled electronically to receive the full benefit of regenerative braking and friction braking.

### Exemplary Battery Protection Operations

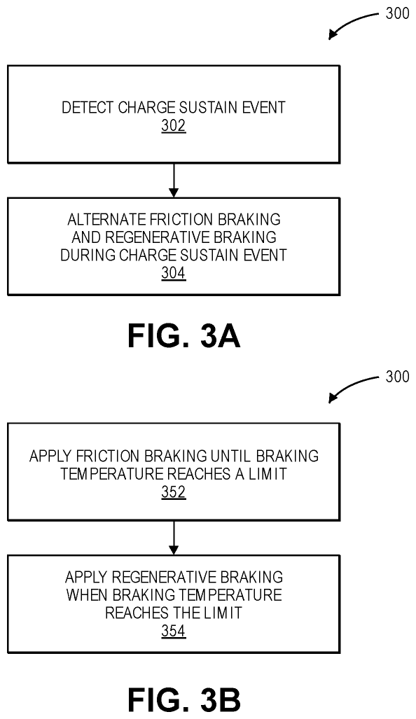

FIG. 3A-3B illustrates exemplary flow diagrams of battery protection operations 300 and 350 for the vehicle 100 of FIG. 1 and systems of FIGS. 2A-2D.

Referring to operation 300 of FIG. 3A, at operation 302, a charge sustain event is detected. For example, a charge sustain event can be a vehicle at or near a top of a hill or going down a hill in a lift condition (no pedals pressed) at break-away speed and the battery is fully charged at its maximum state of charge (SOC) or voltage limit. At operation 304, for the detected charge sustain event, vehicle 100 using brake system 210 and powertrain system 220 alternates between friction braking and regenerative braking to sustain a charge for battery 103 while preventing battery 103 from overcharging.

Referring to operation 350 of FIG. 3B, at operation 352, friction braking can be applied until braking temperature reaches a limit. For example, friction brakes 212 can include a temperature sensor to measure a temperature of the friction brakes which can comprise of a rotor and contact pads. The measured temperature can be received by VCU 207. Once the measured temperature reaches a limit, at operation 352, VCU 207 can signal to BCU 212 to modify or blend-out friction braking in order to reduce braking temperature. In this way, charge-sustain braking can also prevent braking components from overheating.

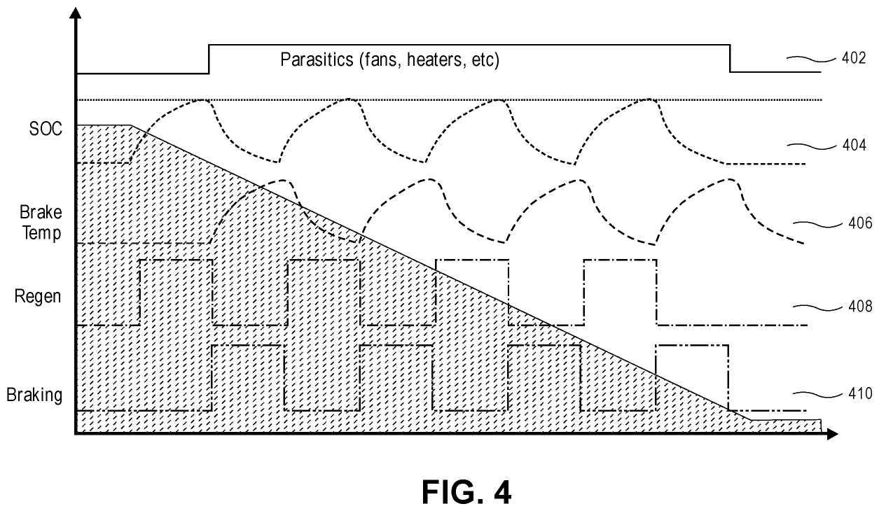

FIG. 4 illustrates exemplary graphs 408 and 410 of switching or alternating between friction braking and regenerative braking for vehicle 100 with relation to braking temperature 406, battery state of charge (SOC) 404, and parasitic elements 402 in a downhill condition or fast acceleration state for vehicle 100. Referring to FIG. 4, graph 408 shows regenerative braking turning on or off that is offset with graph 410 showing friction braking turning on and off. As shown, as regenerative braking turns off, friction braking turns on and vice versa.

As shown in graphs 404 and 406, as the state of charge (SOC) of battery 103 rises when regenerative braking is on and the electric motor 203 operates as a power generator to charge battery 103. As the SOC rises to near or at full charge, regenerative braking is turned off and friction braking is turned on. When friction braking is turned on, braking temperature rises as shown in graph 406. When braking temperature reaches a certain level or limit, friction braking is turned off and regenerative braking is turned on to cool down the friction brakes. This alternating process continues until vehicle 100 has reached a stable condition, e.g., at the bottom of a hill 407 or the vehicle has stopped. Graph 402 illustrates that parasitic elements (e.g., fans, heaters, etc.) may affect SOC and brake temperature during the downhill or fast acceleration braking operation.

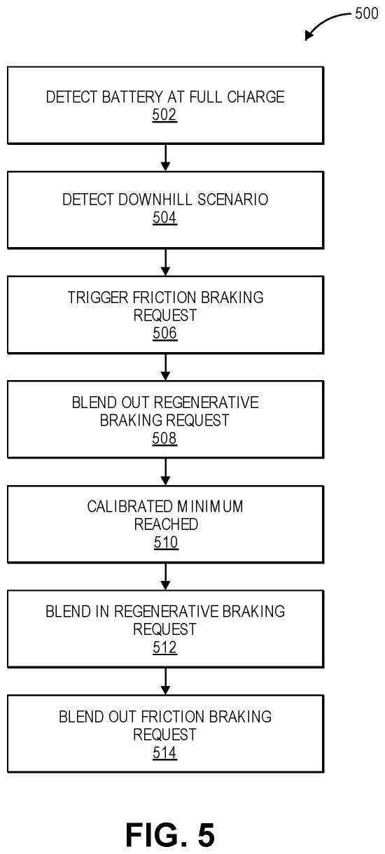

FIG. 5 illustrates another exemplary flow diagram of a battery protection operation 500 for the vehicle 100 of FIGS. 1-2D. Referring to FIG. 5, at operation 502, battery 103 is detected if it is at full charge or state of charge (SOC) is at its limit. At operation 504, a downhill scenario is detected. For one example, VCU 204 can receive location information from location information source 202 to determine if vehicle 100 is at or near the top of a hill or going down a hill at break-away speed. If battery 103 is fully charged and vehicle 100 is in a downhill scenario and regenerative braking is occurring, at operation 506, friction braking is triggered to blend-out regenerative braking at operation 508. At operation 510, a calibrated minimum is detected. For example, referring to graph 404 of FIG. 4, when the SOC hits a minimum, a calibrated minimum is reached. At operation 512, if a calibrated minimum is reached, regenerative braking is blended-in and friction braking is blended-out at operation 514.

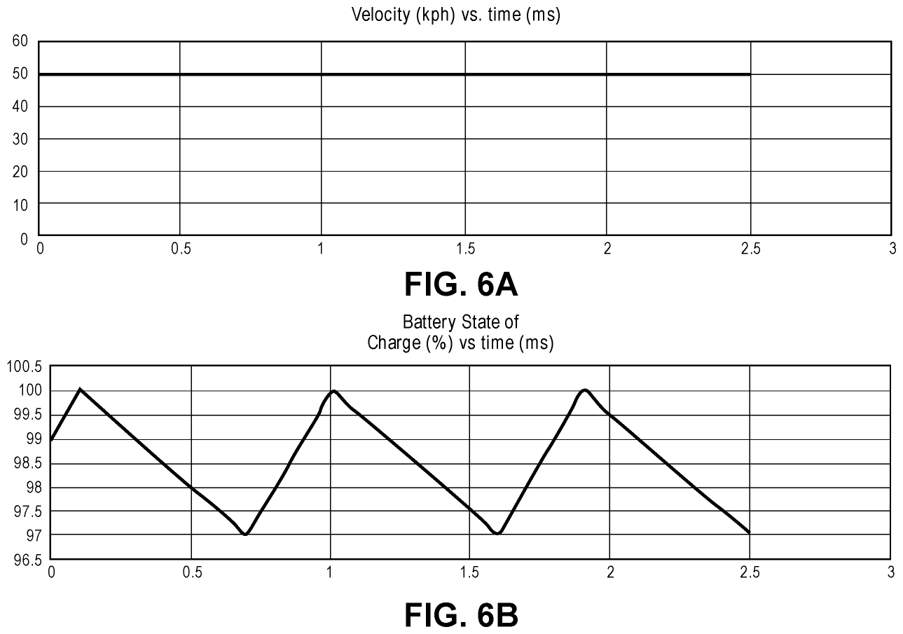

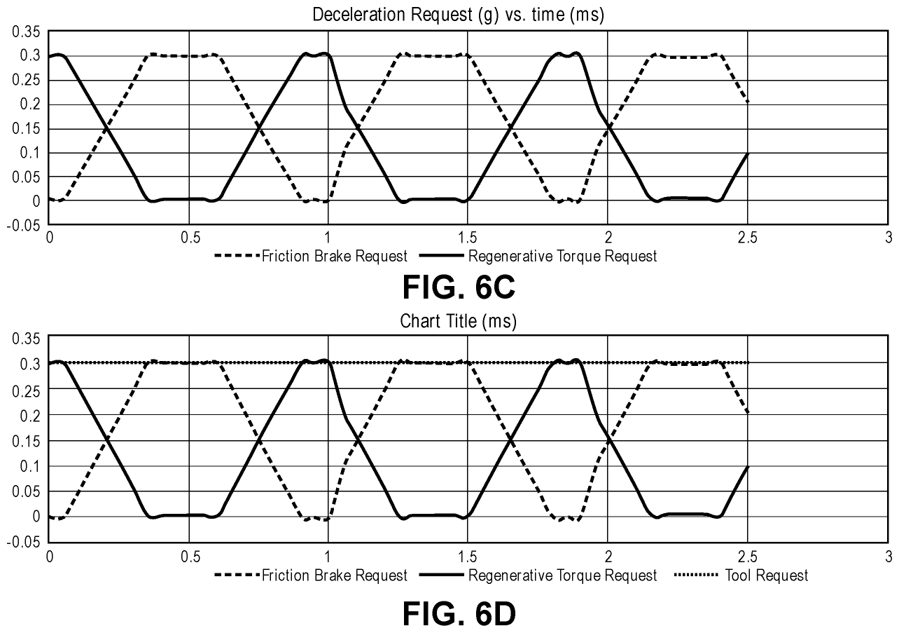

FIG. 6A-6D illustrates exemplary graphs of switching or alternating between friction braking and regenerative braking with relation to vehicle velocity and battery state of charge (SOC) during a downhill situation. Referring to FIG. 6A, during a downhill situation, the velocity for vehicle 100 can be at 50 km/h for a period of 2.5 milliseconds (ms). Referring to FIG. 6B, for one example, the SOC reaches 100% during regenerative braking mode and decreases to 97% during friction braking mode. Referring to FIGS. 6C and 6D, signals to trigger friction braking and regenerative braking are alternating or offsetting to cause the SOC to rise to at or near 100% and to sustain a charge of 97% for battery 103. Table 1 below illustrate exemplary data values for time, velocity, battery state of charge, friction brake requests, regenerative torque requests and total requests during a protective operation.

TABLE 1

| | | | | Regenerative | |
|---|---|---|---|---|---|
| | | Battery State | Friction Brake | Torque | Total |
| Time | Velocity | of Charge | Request | Request | Request |
| 0 | 50 | 99 | 0 | 0.3 | 0.3 |
| 0.05 | 50 | 99.5 | 0 | 0.3 | 0.3 |
| 0.1 | 50 | 100 | 0.05 | 0.25 | 0.3 |
| 0.15 | 50 | 99.75 | 0.1 | 0.2 | 0.3 |
| 0.2 | 50 | 99.5 | 0.15 | 0.15 | 0.3 |
| 0.25 | 50 | 99.25 | 0.2 | 0.1 | 0.3 |
| 0.3 | 50 | 99 | 0.25 | 0.05 | 0.3 |
| 0.35 | 50 | 98.75 | 0.3 | 0 | 0.3 |
| 0.4 | 50 | 98.5 | 0.3 | 0 | 0.3 |
| 0.45 | 50 | 98.25 | 0.3 | 0 | 0.3 |
| 0.5 | 50 | 98 | 0.3 | 0 | 0.3 |
| 0.55 | 50 | 97.75 | 0.3 | 0 | 0.3 |
| 0.6 | 50 | 97.5 | 0.3 | 0 | 0.3 |
| 0.65 | 50 | 97.25 | 0.25 | 0.05 | 0.3 |
| 0.7 | 50 | 97 | 0.2 | 0.1 | 0.3 |
| 0.75 | 50 | 97.5 | 0.15 | 0.15 | 0.3 |
| 0.8 | 50 | 98 | 0.1 | 0.2 | 0.3 |
| 0.85 | 50 | 98.5 | 0.05 | 0.25 | 0.3 |
| 0.9 | 50 | 99 | 0 | 0.3 | 0.3 |
| 0.95 | 50 | 99.5 | 0 | 0.3 | 0.3 |
| 1 | 50 | 100 | 0 | 0.3 | 0.3 |
| 1.05 | 50 | 99.75 | 0.1 | 0.2 | 0.3 |
| 1.1 | 50 | 99.5 | 0.15 | 0.15 | 0.3 |
| 1.15 | 50 | 99.25 | 0.2 | 0.1 | 0.3 |
| 1.2 | 50 | 99 | 0.25 | 0.05 | 0.3 |
| 1.25 | 50 | 98.75 | 0.3 | 0 | 0.3 |
| 1.3 | 50 | 98.5 | 0.3 | 0 | 0.3 |
| 1.35 | 50 | 98.25 | 0.3 | 0 | 0.3 |
| 1.4 | 50 | 98 | 0.3 | 0 | 0.3 |
| 1.45 | 50 | 97.75 | 0.3 | 0 | 0.3 |
| 1.5 | 50 | 97.5 | 0.3 | 0 | 0.3 |
| 1.55 | 50 | 97.25 | 0.25 | 0.05 | 0.3 |
| 1.6 | 50 | 97 | 0.2 | 0.1 | 0.3 |
| 1.65 | 50 | 97.5 | 0.15 | 0.15 | 0.3 |
| 1.7 | 50 | 98 | 0.1 | 0.2 | 0.3 |
| 1.75 | 50 | 98.5 | 0.05 | 0.25 | 0.3 |
| 1.8 | 50 | 99 | 0 | 0.3 | 0.3 |
| 1.85 | 50 | 99.5 | 0 | 0.3 | 0.3 |
| 1.9 | 50 | 100 | 0 | 0.3 | 0.3 |
| 1.95 | 50 | 99.75 | 0.1 | 0.2 | 0.3 |
| 2 | 50 | 99.5 | 0.15 | 0.15 | 0.3 |
| 2.05 | 50 | 99.25 | 0.2 | 0.1 | 0.3 |
| 2.1 | 50 | 99 | 0.25 | 0.05 | 0.3 |
| 2.15 | 50 | 98.75 | 0.3 | 0 | 0.3 |
| 2.2 | 50 | 98.5 | 0.3 | 0 | 0.3 |
| 2.25 | 50 | 98.25 | 0.3 | 0 | 0.3 |
| 2.3 | 50 | 98 | 0.3 | 0 | 0.3 |
| 2.35 | 50 | 97.75 | 0.3 | 0 | 0.3 |
| 2.4 | 50 | 97.5 | 0.3 | 0 | 0.3 |
| 2.45 | 50 | 97.25 | 0.25 | 0.05 | 0.3 |
| 2.5 | 50 | 97 | 0.2 | 0.1 | 0.3 |

### Exemplary Data Processing or Computing System

FIG. 7 illustrates one example of a data processing system or computing system 700, which can be used for any of the systems or electronic control units (ECU) as shown in FIG. 1-6. Although FIG. 7 illustrates various components of a data processing or computing system, the components are not intended to represent any particular architecture or manner of interconnecting the components, as such details are not germane to the disclosed examples or embodiments. Network computers and other data processing systems or other consumer electronic devices, which have fewer components or perhaps more components, may also be used with the disclosed examples and embodiments.

Referring to FIG. 7, computing system 700, which is a form of a data processing or computing system, includes a bus 701, which is coupled to processor(s) 702 coupled to cache 704, display controller 714 coupled to a display 715, network interface 717, non-volatile storage 706, memory controller coupled to memory 710, I/O controller 718 coupled to I/O devices 720, and database 712. Processor(s) 702 can include one or more central processing units (CPUs), graphical processing units (GPUs), a specialized processor or any combination thereof. Processor(s) 702 can retrieve instructions from any of the memories including non-volatile storage 706, memory 710, or database 712, and execute the instructions to perform operations described in the disclosed examples and embodiments.

Examples of I/O devices 720 include mice, keyboards, printers and other like devices controlled by I/O controller 718. Network interface 717 can include modems, wired and wireless transceivers and communicate using any type of networking protocol including wired or wireless WAN and LAN protocols including LTE and Bluetooth® standards. Memory 710 can be any type of memory including random access memory (RAM), dynamic random-access memory (DRAM), which requires power continually in order to refresh or maintain the data in the memory. Non-volatile storage 706 can be a mass storage device including a magnetic hard drive or a magnetic optical drive or an optical drive or a digital video disc (DVD) RAM or a flash memory or other types of memory systems, which maintain data (e.g. large amounts of data) even after power is removed from the system.

For one example, memory devices 710 or database 712 can store GPS or location information for vehicle 100. For other examples, memory devices 710 or database 712 can store user information of vehicle 100. Although memory devices 710 and database 712 are shown coupled to system bus 701, processor(s) 702 can be coupled to any number of external memory devices or databases locally or remotely by way of network interface 717, e.g., database 712 can be secured storage in a cloud environment. For one example, processor(s) 702 can implement techniques and operations described in FIGS. 1-6D.

Examples and embodiments disclosed herein can be embodied in a data processing system architecture, data processing system or computing system, or a computer-readable medium or computer program product. Aspects, features, and details of the disclosed examples and embodiments can take the hardware or software or a combination of both, which can be referred to as a system or engine. The disclosed examples and embodiments can also be embodied in the form of a computer program product including one or more computer readable mediums having computer readable code which can be executed by one or more processors (e.g., processor(s) 702) to implement the techniques and operations disclosed in FIGS. 1-6D.

In the foregoing specification, the invention has been described with reference to specific exemplary embodiments thereof. It will, however, be evident that various modifications and changes may be made thereto without departing from the broader spirit and scope of disclosed examples and embodiments. The specification and drawings are, accordingly, to be regarded in an illustrative rather than a restrictive sense.

What is claimed is:

1. A data processing system comprising:
a first controller to control friction braking; and
a second controller coupled to the first controller and to an electric motor powered by a battery, the second controller configured to
control the electric motor to generate torque or generate electrical energy to recharge the battery,
detect a condition to signal the first controller to modulate friction braking, and
signal the first controller to modulate friction braking if the condition is detected.

2. The data processing system of claim 1, wherein the second controller is further configured to control the electric motor to generate electrical energy when friction braking is not applied by the first controller.

3. The data processing system of claim 1, further comprising:
a location data source to provide location data; and
one or more sensors to provide sensor data.

4. The data processing system of claim 3, wherein the second controller is further configured to detect the condition based on location data or sensor data.

5. The data processing system of claim 4, wherein the first controller is configured to modulate friction braking at a frequency range of greater than 100 hertz and less than 400 hertz.

6. A vehicle comprising:
a braking system to provide friction braking for the vehicle;
a powertrain system to control an electric motor powered by a rechargeable battery for the vehicle and to invert the electric motor in providing regenerative braking; and
a vehicle control unit (VCU) coupled to the braking system and powertrain system and configured to
detect a condition to control the braking system and powertrain system to switch between regenerative braking and friction braking, and
control the braking system and powertrain system to switch between regenerative braking while the condition is detected.

7. The vehicle of claim 6, further comprising:
a location data source to provide the VCU with vehicle location information including data indicating that the vehicle is at a top of a hill or going down a hill; and
one or more sensors to provide sensor data to the VCU including temperature information for one or more braking components, temperature related to the rechargeable battery, or state of charge (SOC) or voltage level related to the rechargeable battery.

8. The vehicle of claim 7, wherein the condition detected by the VCU includes the vehicle is at a top of a hill or going down a hill, the temperature of one or more braking components is at or beyond a threshold, the temperature related to the rechargeable battery is at or beyond a threshold, or the state of charge (SOC) or voltage level of the rechargeable battery is at or beyond a threshold.

9. The vehicle of claim 6, wherein the VCU is to control the braking system and powertrain system to alternate between regenerative braking and friction braking at a frequency range of greater than 100 hertz and less than 400 hertz.

10. The vehicle of claim 6, wherein the VCU is to control the braking system and powertrain system to blend-out regenerative braking and blend-in friction braking and blend-out friction braking and blend-in regenerative braking at a frequency range of greater than 100 hertz and less than 400 hertz.

11. A non-transitory computer-readable medium including instructions, which if executed by a computer, causes the computer to implement an operation comprising:
detecting a condition to alternate between regenerative braking and friction baking for a vehicle having an electric motor powered by a battery; and
switching between regenerative braking and friction braking if the condition is detected.

12. The non-transitory computer-readable medium of claim 11 including instructions, which if executed by the computer, causes the computer to implement an operation comprising:
detecting a condition including the vehicle is at a top of a hill or going down a hill.

13. The non-transitory computer-readable medium of claim 11 including instructions, which if executed by the computer, causes the computer to implement an operation comprising:
detecting a condition including a braking temperature of the vehicle at or beyond a threshold or a battery temperature at or beyond a threshold.

14. The non-transitory computer-readable medium of claim 11 including instructions, which if executed by the computer, causes the computer to implement an operation comprising:
detecting a condition including a state of charge (SOC) or voltage level of the rechargeable battery at or beyond a threshold.

15. The non-transitory computer-readable medium of claim 11 including instructions, which if executed by the computer, causes the computer to implement an operation comprising:
switching between regenerative braking and friction braking at a frequency range of greater than 100 hertz and less than 400 hertz.

16. In a vehicle powered by an electric motor and battery, the vehicle including a vehicle control unit (VCU) to control friction braking and regenerative braking for the vehicle, the VCU configured to implement a method comprising:
detecting a condition to switch back and forth between regenerative braking and friction baking; and
controlling switching between regenerative braking and friction braking if the condition is detected.

17. The method of claim 16, wherein the switching between regenerative braking and friction braking is at a frequency range of greater than 100 hertz and less than 400 hertz.

18. The method of claim 16, wherein the detected condition includes a charge sustain event including the vehicle at a top of a hill or going down a hill, a temperature related to one or more braking components at or beyond a threshold, a temperature related to the battery at or beyond a threshold, or a state of charge (SOC) or voltage level of the battery at or beyond a threshold.

19. The method of claim 16, wherein switching between regenerative braking and friction braking includes alternating between regenerative braking and friction braking.

20. The method of claim 16, wherein switching between regenerative braking and friction braking includes:
blending-out regenerative braking; and
blending-in friction braking.

21. The method of claim 20, wherein switching between regenerative braking and friction braking further includes:
blending-out friction braking; and
blending-in regenerative braking.
